(19) United States
(12) Patent Application Publication
(10) Pub. No.: US 2010/0312776 A1
(43) Pub. Date: Dec. 9, 2010

(54) INTELLIGENT PERFORMANCE ANALYSIS AND ISOLATON OF POTENTIAL PROBLEM QUERIES

(75) Inventors: Stephanie A. Burrichter, Rochester, MN (US); Paul R. Day, Rochester, MN (US); Randy L. Egan, Rochester, MN (US); Roger A. Mittelstadt, Byron, MN (US)

Correspondence Address: WOOD, HERRON & EVANS, L.L.P. (IBM), 2700 CAREW TOWER, 441 VINE STREET, CINCINNATI, OH, 45202, US

(73) Assignee: INTERNATIONAL BUSINESS MACHINES CORPORATION, Armonk, NY (US)

(21) Appl. No.: 12/478,203

(22) Filed: Jun. 4, 2009

(51) Int. Cl. G06F 17/30

(52) U.S. Cl. 707/759; 707/769; 707/713

(57) ABSTRACT

A method, apparatus and program product for processing a database query for intelligent performance analysis and isolation of queries associated with potential problems is provided. The method may be performed in a computing system of the type that includes a query optimizer. The method comprises comparing a number of times processing of the database query has been prematurely terminated with a threshold, wherein the number is based upon tracked termination information of the database query. The method further comprises automatically collecting diagnostic information about the database query based upon the comparison, wherein the collected diagnostic information is usable for improving a second execution of the database query.

### FIELD OF THE INVENTION

The invention relates to computing systems, and in particular, to the processing of database queries by database management systems.

### BACKGROUND OF THE INVENTION

Databases are used to store information for a number of purposes, including for various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's) are typically used to access the information stored in databases. However, conventional database management systems often require tremendous resources to handle the heavy workloads required by conventional database usage. As such, significant resources have been devoted to increasing the performance of conventional database management systems and conventional databases. For example, in the hardware realm, increases in microprocessor performance, coupled with improved memory management systems, have typically improved the number of queries that a particular microprocessor can perform in a given unit of time. Furthermore, the use of multiple microprocessors and/or multiple networked computers has often increased the capacities of many database management systems. As another example, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database.

Furthermore, significant development efforts have been directed toward query optimization, whereby the execution of particular searches, or queries, is optimized in an automated manner to minimize the amount of resources required to execute each query. A query optimizer typically generates, for each submitted query, an access plan. In generating an access plan, a query optimizer generally creates multiple potential access plans then selects the fastest and/or most efficient among those potential access plans based upon the cost of each plan. For example, the cost of each plan may represent the amount of resources expected to be utilized by the plan (typically expressed in the expected amount of time to execute), and as such, selecting the plan with the lowest cost typically results in the most efficient and/or quickest execution of a query.

Despite the significant hardware, software, and optimization advances, some queries often spend a relatively long time executing or processing, particularly when those queries are complex and/or involve a large amount of data. Moreover, statistical imprecision during optimization may result in the selection of a suboptimal access plan and a long processing query. Additionally, poor configuration of a database and/or data thereof often results in queries that must spend a relatively long time processing. For example, queries accessing poorly configured tables that lack a corresponding index and/or statistic typically spend a longer period of time processing than queries accessing more adequately configured tables. Other factors during the execution of a query may also increase the processing time of a query. For example, a system resource, such as CPU or I/O resource needed to process a query, may become unavailable or overloaded during the query's processing due to other tasks needing the system resource.

As a result of these and other reasons for long processing queries, a user may become impatient or may not be able to wait for a long processing query to finish executing. For example, the user may want to execute other queries, and because the long processing query may affect the performance of the other queries the user wants to execute, the user may not want to wait for the long processing query to finish processing. The user may therefore choose to prematurely terminate the query, such as through a system request to end the query or a system request to cancel the job. Alternatively, a long processing query may time out if established time or resource constraints for the query are exceeded, which results in a system-initiated premature termination of the query.

Some tools do exist to improve the performance of a long processing query. However, users often do not utilize the tools because the tools may require, for example, advanced user knowledge, manual initiation of a tool, running reports, collecting database monitor records, and/or expert analysis. Particularly for a user lacking advanced knowledge, the user may have to call upon and wait for a database administrator to manually initiate a tool, re-execute the query with the tool, analyze the results, implement improvements, and re-execute the query again with the improvements.

Furthermore, upon terminating a query before the processing completes, not only did a user waste his or her time and valuable system resources waiting for the query to finish executing, but the user may still not have an answer to the query. Thus, the user typically has to process the query again, often subject to the same delays, and with a good chance that the user will once again grow impatient and terminate the query. This cycle may typically be repeated many times by many users, resulting in more wasted time and unimproved queries. Additionally, other queries may be negatively affected while a long processing query is executing, also resulting in wasted time and resources.

A need therefore exists in the art for improving the performance of queries, and in particular, a more intelligent and user friendly approach to improving the processing of database queries, thus resulting in fewer early terminations of queries, improved performance, and more satisfied users.

### SUMMARY OF THE INVENTION

The invention addresses these and other problems associated with the prior art by providing a method that compares tracked termination information of a database query with a threshold and, based on the comparison, automatically collects diagnostic information about the database query that is usable for improving a second execution of the database query. By doing so, the invention aids administrators and troubleshooters in addressing “problem” queries independent of the behavior of the user running the queries.

In specific embodiments, a method is provided for executing a database query in a computing system of the type that includes a query optimizer. The method comprises comparing the number of times processing of the database query has been prematurely terminated with a threshold, wherein the number is based upon tracked termination information of the database query. The method further comprises automatically collecting diagnostic information about the database query based upon the comparison, wherein the collected diagnostic information is usable for improving a second execution of the database query.

These and other advantages and features, which characterize the invention, are set forth in the claims annexed hereto and forming a further part hereof. However, for a better understanding of the invention, and of the advantages and objectives attained through its use, reference should be made to the drawings, and to the accompanying descriptive matter, in which there is described exemplary embodiments of the invention.

### BRIEF DESCRIPTION OF THE DRAWINGS

FIG. 1 is a block diagram of a networked computer system incorporating a database management system within which is implemented tracking of premature terminations of database queries consistent with embodiments of the invention;

FIG. 2 is a block diagram illustrating the principal components and flow of information in the database management system of FIG. 1;

FIG. 3A is a flow chart illustrating a query evaluation process including an early termination evaluation process consistent with embodiments of the invention;

FIG. 3B is a flow chart illustrating certain pre-processing steps associated with the early termination evaluation process as illustrated in FIG. 3A;

FIG. 3C is a flow chart illustrating certain post-termination steps associated with the early termination evaluation process as illustrated in FIG. 3A;

FIG. 4A is a flow chart illustrating a query evaluation process including a function check evaluation process consistent with embodiments of the invention;

FIG. 4B is a flow chart illustrating certain pre-processing steps associated with the function check evaluation process as illustrated in FIG. 4A; and

FIG. 4C is a flow chart illustrating certain post-termination steps associated with the function check evaluation process as illustrated in FIG. 4A.

It should be understood that the appended drawings are not necessarily to scale, presenting a somewhat simplified representation of various preferred features illustrative of the basic principles of embodiments of the invention. The specific features consistent with embodiments of the invention disclosed herein, including, for example, specific dimensions, orientations, locations, sequences of operations and shapes of various illustrated components, will be determined in part by the particular intended application, use and/or environment. Certain features of the illustrated embodiments may have been enlarged or distorted relative to others to facilitate visualization and clear understanding.

### DETAILED DESCRIPTION

Embodiments consistent with the invention include a method, apparatus and program product to track termination information associated with at least one premature termination of a database query to improve the processing of the database query. A “premature” termination of a database query may be practically any time the processing of a database query stops before the processing of the database query completes. Embodiments consistent with the invention may have applicability with practically any type of query that may be prematurely terminated, including user-initiated terminations (e.g., user cancellations of a query) and terminations initiated by the system (e.g., error-based terminations). A user consistent with the invention may be practically anyone capable of issuing queries to a database management system, including an end user, a database administrator and/or applications configured to issue queries to the database management system and/or to prematurely terminate database queries.

Termination information consistent with the invention may be practically any information associated with the premature termination of a database query. Termination information for a database query may include, for example, a number of times the query has been prematurely terminated, an amount of processing time before processing of the database query is prematurely terminated, when processing of the database query is prematurely terminated, a system configuration (e.g., priority of the database query, memory allocated to the database query, number of other queries processing when the database query was prematurely terminated, etc.), a user that prematurely terminates processing of the database query, a specific error that results in termination of the database query, a pattern in how processing of the database query is prematurely terminated, etc. Termination information for a database query may also be user specific, e.g., how many times a specific user prematurely terminated the database query, how much time a specific user allowed the query to process before prematurely terminating the query, etc.

Termination information may be used to determine that a particular query is associated with a potential problem. For example, termination information may indicate that a query is prematurely terminated by many users, a query is always terminated by the same user, a query is usually terminated at approximately the same time of day and/or after substantially similar amounts of times, etc. Additionally, termination information may be used to build a waiting value for a user. A waiting value represents the approximate amount of time a user has historically waited before prematurely terminating processing of at least one database query. Furthermore, termination information may be used to generate suggestions to improve the processing of database queries consistent with embodiments of the invention. Termination information may be retrieved, stored, and/or updated in an access plan of the database query.

Conventionally, when a user wants to gather information from a database, they may query the data using an application or web interface. If for some reason the query does not perform as expected (e.g., the query takes too long), the user will often give up and use a system request to cancel the query. When the user utilizes monitoring and performance tools to monitor the query, however, information associated with those monitoring and performance tools may either be incomplete or non-existent upon the cancellation of the query. However, a trouble-shooting third party, such as a database administrator, may be interested in the data, statistics, and timing for any poorly performing query.

This data is made available by the exemplary processes described herein. The computer system identifies “problem” queries through use of a threshold value, “N.” The threshold N can be calculated in a variety of ways. For example, based on the proportion of query runs to the number of cancel requests; by a historical study of user habits for cancelling queries; by how long the query is allowed to run before cancelling; or dependent on how long since the last query access plan has been built. Alternatively, the threshold N may be set to a default, or may be set by a user of the system.

The system intelligently determines when a given query has been subject to premature termination. As the pattern associated with premature terminations of the identified query approaches the threshold value N, additional steps are taken by the database query system to intelligently deal with the query. These steps may include, for example: the collection, monitoring, and transfer of data on subsequent runs of the query; completing a cancelled “problem” query as a lower-priority batch job; and allowing the user to retry the query with changed parameters. Each of these steps is illustrated in the Drawings and described more fully below. This method compares tracked termination information of a database query with a threshold and, based on the comparison, automatically collects diagnostic information about the database query that is usable for improving a second execution of the database query.

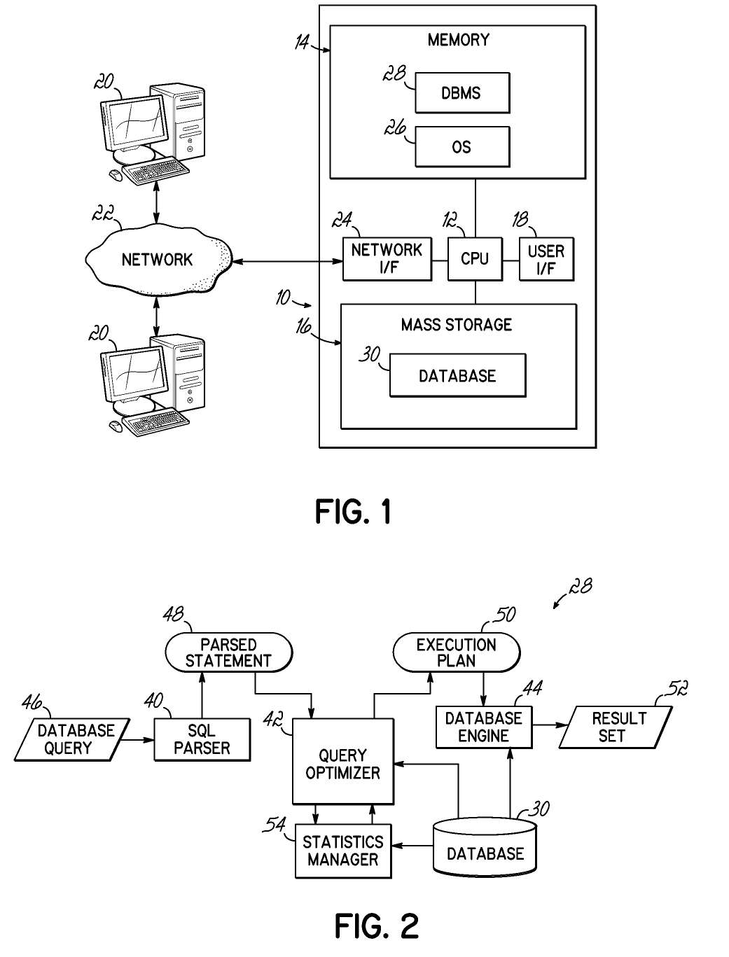

Turning now to the Drawings, wherein like numbers denote like parts throughout the several views, FIG. 1 illustrates an exemplary hardware and software environment for an apparatus 10 suitable for implementing a database management system consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computing system,” although it should be appreciated that the term “apparatus” may also include other suitable programmable electronic devices consistent with the invention.

The computing system 10 includes at least one central processing unit (“CPU”) 12 coupled to a memory 14. Each CPU 14 is typically implemented in hardware using circuit logic disposed on one or more physical integrated circuit devices, or chips. Each CPU 12 may be one or more microprocessors, micro-controllers, field programmable gate arrays, or ASICs, while memory 14 may include random access memory (RAM), dynamic random access memory (DRAM), static random access memory (SRAM), flash memory, and/or another digital storage medium, typically implemented using circuit logic disposed on one or more physical integrated circuit devices, or chips. As such, memory 14 may be considered to include memory storage physically located elsewhere in the computing system 10, e.g., any cache memory in the at least one CPU 12, as well as any storage capacity used as a virtual memory, e.g., as stored on a mass storage device 16, a computer, or another controller coupled to computer through at least one network interface 24 (illustrated as, and hereinafter, “network I/F” 24) by way of a network 22.

The computing system 10 may include the mass storage device 16, which may also be a digital storage medium, and in specific embodiments includes at least one hard disk drive. Additionally, mass storage device 16 may be located externally to the computing system 10, such as in a separate enclosure or in one or more networked computers (not shown), one or more networked storage devices (including, for example, a tape drive) (not shown), and/or one or more other networked devices (including, for example, a server) (not shown). As such, the computing system 10 may be communicatively coupled to the one or more networked computers, one or more networked storage devices and/or one or more other networked devices through the network 22.

For interface with a user or operator, computing system 10 typically includes a user interface 18 incorporating one or more user input devices (e.g., a keyboard, a mouse, a trackball, a joystick, a touchpad, and/or a microphone, among others) and/or a display (e.g., a CRT monitor, an LCD display panel, and/or a speaker, among others). Otherwise, user input may be received via another computer or terminal, e.g., via a client or single-user computer 20 coupled to computing system 10 over a network 22. This latter implementation may be desirable where computing system 10 is implemented as a server or other form of multi-user computing system. However, it should be appreciated that computing system 10 may also be implemented as a standalone workstation, desktop, or other single-user computing system in some embodiments.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computing system, and that, when read and executed by one or more processors in a computing system, cause that computing system to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to physical and tangible recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computing system (e.g., operating systems, libraries, API's, applications, applets, etc.), it should be appreciated that the invention is not limited to the specific organization and allocation of program functionality described herein.

Computing system 10 operates under the control of an operating system 26, and executes or otherwise relies upon various computer software applications, components, programs, objects, modules, data structures, etc. For example, a database management system (DBMS) 28 may be resident in memory 14 to access and/or perform operations on a database 30 resident in mass storage 16, or alternatively a database system separate from the computing system, such as across a network (not shown). Moreover, various applications, components, programs, objects, modules, etc. may also execute on one or more processors in another computing system coupled to computing system 10 via a network, e.g., in a distributed or client-server computing environment, whereby the processing required to implement the functions of a computer program may be allocated to multiple computing systems over a network.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

FIG. 2 next illustrates in greater detail the principal components of one implementation of the DBMS 28. The principal components of DBMS 28 that are generally relevant to query execution are a Structured Query Language (SQL) parser 40, query optimizer 42 and database engine 44. SQL parser 40 receives from a user (or more typically, an application executed by that user) a database query 46, which in the illustrated embodiment, is provided in the form of an SQL statement. SQL parser 40 then generates a parsed statement 48 therefrom, which is passed to optimizer 42 for query optimization. As a result of query optimization, an execution or access plan 50 is generated. Once generated, the execution plan is forwarded to database engine 44 for execution of the database query on the information in database 30. The result of the execution of the database query is typically stored in a result set, as represented at block 52.

To facilitate the optimization of queries, the DBMS 28 may also include a statistics manager 54. Statistics manager 54 may be used to gather, create, and/or analyze statistical information using database 30 for the query optimizer 42. It will be appreciated by those of ordinary skill in the art, however, that optimizer 42, statistics manager 54, database 30, database engine 44, and/or other components may be accorded different functionality in some embodiments. Moreover, components may be added and/or omitted in some embodiments. Those of ordinary skill in the art will also recognize that the implementation of DBMS 28 illustrated in FIG. 2 is not intended to limit the present invention. Indeed, those skilled in the art will recognize that other alternative hardware and/or software environments may be used without departing from the scope of the invention.

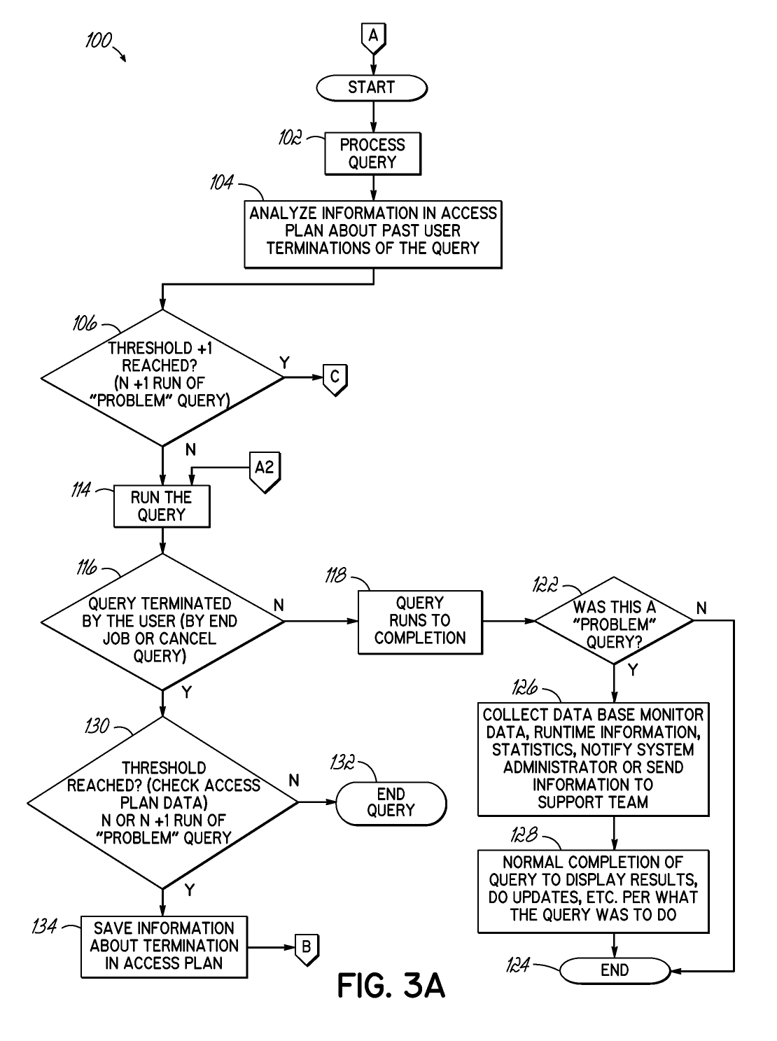

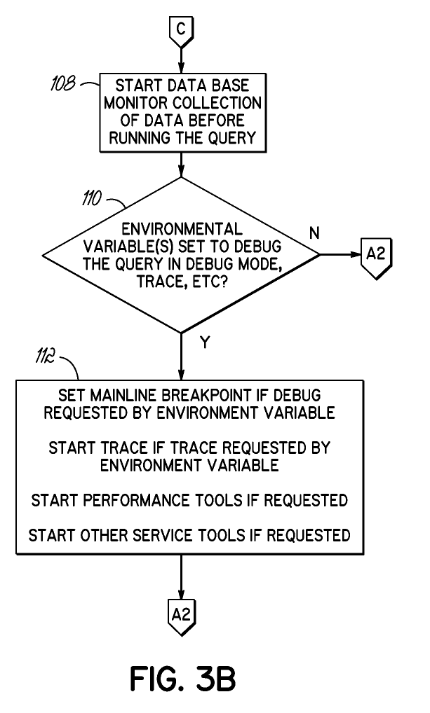

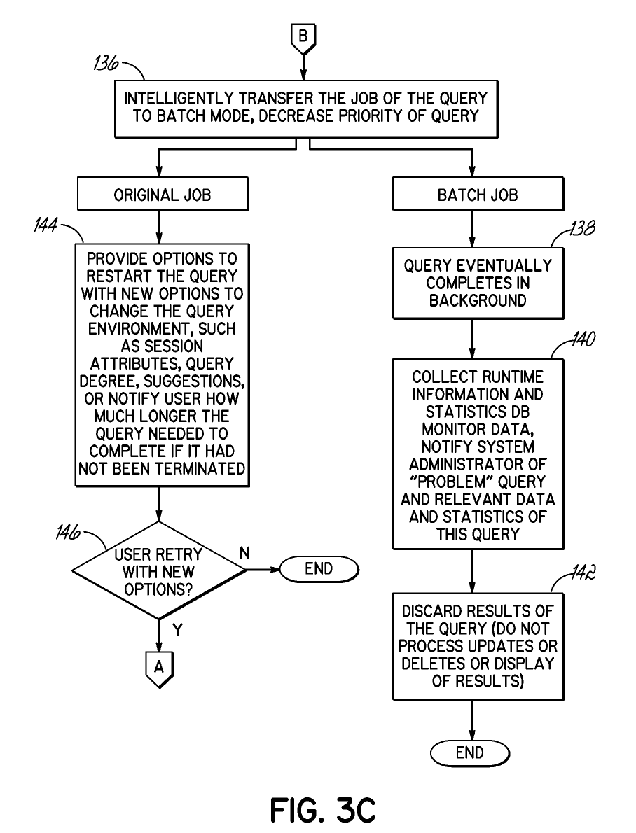

FIG. 3A illustrates a flowchart 100 of a process for executing a database query which can be carried out by the DBMS 28 or another suitable system. The flowchart 100 includes blocks of program code executable to determine whether a query is associated with a termination history as well as perform remedial actions thereupon consistent with embodiments of the invention. Initially, the query is processed (block 102). The program code may then determine past user interactions based upon the history of that query (block 104). In some embodiments, there are is no relevant history for a query. For example, there may be no relevant history for a query when a query is run for the first time and/or when a new user is first evaluating the query.

The program code then evaluates whether a termination history associated with the query has exceeded a termination threshold “N” (e.g., whether the query is a “problem” query) (block 106). When the termination history of the query has exceeded the termination threshold N (e.g., the termination history indicates that the query has been terminated and/or canceled N+1 number of times) (“Yes” branch of decision block 106), pre-processing may be performed on the query as illustrated in FIG. 3B before that query is executed.

With reference to FIG. 3B, and in response to the determination that the termination history of the query has exceeded the termination threshold N (“Yes” branch of decision block 106), data may be collected by a database monitor (block 108) and environmental variables associated with the query may be checked (block 110). For example, the query may be associated with environmental variables that indicate a processing request upon the Nth run of a query. The processing request may specify that a breakpoint is to be set, a debug mode is to be entered, a trace is to be started, another service tool is to be used to monitor the query and/or another processing setting associated with the query is to be changed. When at least one environmental variable has been set to include a processing request (e.g., for example, the use of debug mode, trace, and/or another service tool, etc.) (“Yes” branch of decision block 110), the processing settings associated with the query are changed accordingly (block 112).

Returning to FIG. 3A, in response to determining that the termination history of the query has not exceeded the termination threshold N (“No” branch of decision block 106), in response to determining that at least one environmental variable has not been set (“No” branch of decision block 110) and/or in response to changing processing settings associated with the query (block 112), the query is executed (block 114). It may then be determined whether the query concluded or was prematurely terminated (e.g., for example, the query was prematurely terminated by a user, by the end of a job associated with the query, and/or by a cancellation of the query) (block 116). When it is determined that the query ran to completion (“Yes” branch of decision block 116), an indication of that query completion may be provided (e.g., that the query runs to completion) (block 118) and the query is again evaluated to determine whether the query is a “problem” query (block 122). When the query is not a problem query (e.g., for example, the termination history of the query has not exceeded the termination threshold N) (“No” branch of decision block 122), the process may end (block 124). When the query is a “problem” query (“Yes” branch of decision block 122), the system performs additional steps. These steps may include storing and/or analyzing the information generated by the database monitor system. For example, information associated with database monitoring, runtime information and/or statistics may be collected, and the user who initiated the query, a system administrator and/or a support team may be notified of that information (block 126). The query then completes as normal (block 128), and the process may end (block 124).

Returning to block 116, when it is determined that the query prematurely terminates (“Yes” branch of decision block 116), the system may determine whether the termination history, including the present termination, meets the threshold N such that the query is determined to be a “problem” query (decision block 130). When the termination history of the query has not exceeded the termination threshold N (“No” branch of decision block 130), the query is terminated as instructed (block 132). When the threshold has been reached (“Yes” branch of decision block 130), the termination information is saved to the query access plan (block 134), and the query is not terminated but instead continues to run in the background as illustrated in FIG. 3C.

With reference to FIG. 3C, the terminated query is transferred to batch mode and the priority of that query is decreased (block 136). As such, the query may be restarted, processed and/or completed as a “batch job” at a lower priority in the “background” of the system, such that the query processes without user intervention and/or input, and is typically processed with fewer resources and/or after higher priority queries processes (block 138). After completion of the query, information associated with the runtime of the query, as well as statistics from the database monitoring, may be collected from the batch job, and the system administrator may be notified of the “problem” query completion as well as relevant data and/or statistics associated therewith in accordance with the evaluation processes set up by the administrator (block 140). Data may be collected before, during, and/or after the running of the batch job as appropriate. Therefore, although the user has terminated the query, the system has intelligently put it in the background and let it run to completion so that important information and statistics can be gathered to assist in the analysis of why the query took so long to run. However, the query results are discarded, and do not become part of any result set associated with the original query (block 142).

In addition to the execution of the batch job as described above, an option to restart, continue and/or otherwise re-execute the query may be provided to the user (block 144). In some embodiments, the option to re-execute the query may allow the user to change the query environment or query parameters, such as to change various query options to change the query implementation and optimization plan. Moreover, the option may allow the user to change query session attributes, such as changing a degree of parallelism for the query, a job priority of the query, resource allocations, or some other environmental option that would alter the way the query runs. Moreover, the option may provide suggestions to help instruct the user as to query information and/or resolve the performance of the “problem” query. For example, an estimated query completion time may be communicated to the user, informing the user that if they had waited so many seconds or minutes longer, the “problem” query would have completed. As a further example, a suggestion may include information about changes in the environment and optimization plan, or recommend changing the query session attributes, changing the degree of parallelism of the query, changing the job priority of the query, changing the resource allocation to the query, and/or selecting another environmental option that may alter the way the query is processed. Should the user choose to restart, continue and/or re-execute the query (“Yes” branch of decision block 146), the process repeats as illustrated. Should the user choose not to restart, continue and/or re-execute the query (“No” branch of decision block 146) the program code may end.

The above intelligence can also be used as input to collect information for other situations besides user termination of “problem” queries. For example, the repeated occurrence of a program failure (such as a function check) can be treated in the same manner as repeated user cancel request. A threshold value K for system-generated errors may be calculated or otherwise set differently than the threshold N for termination requests as described above.

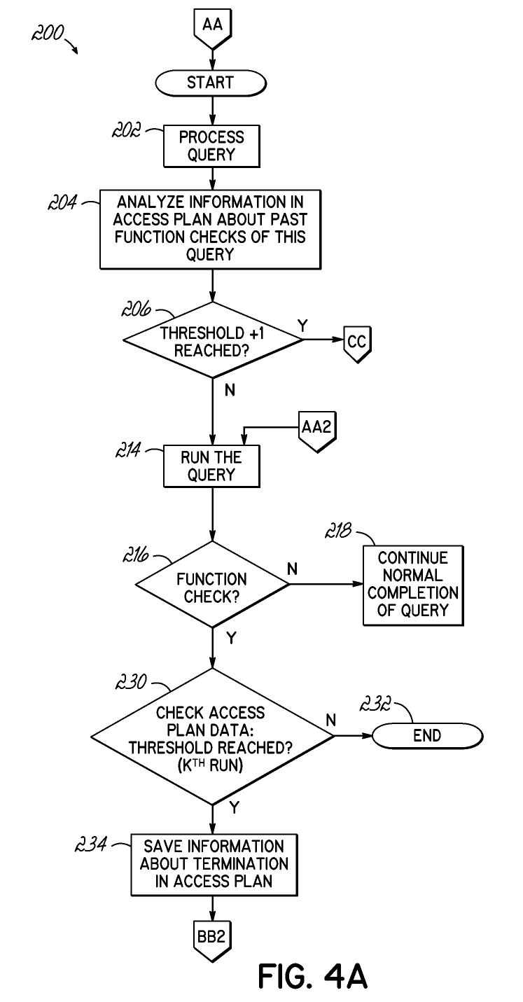

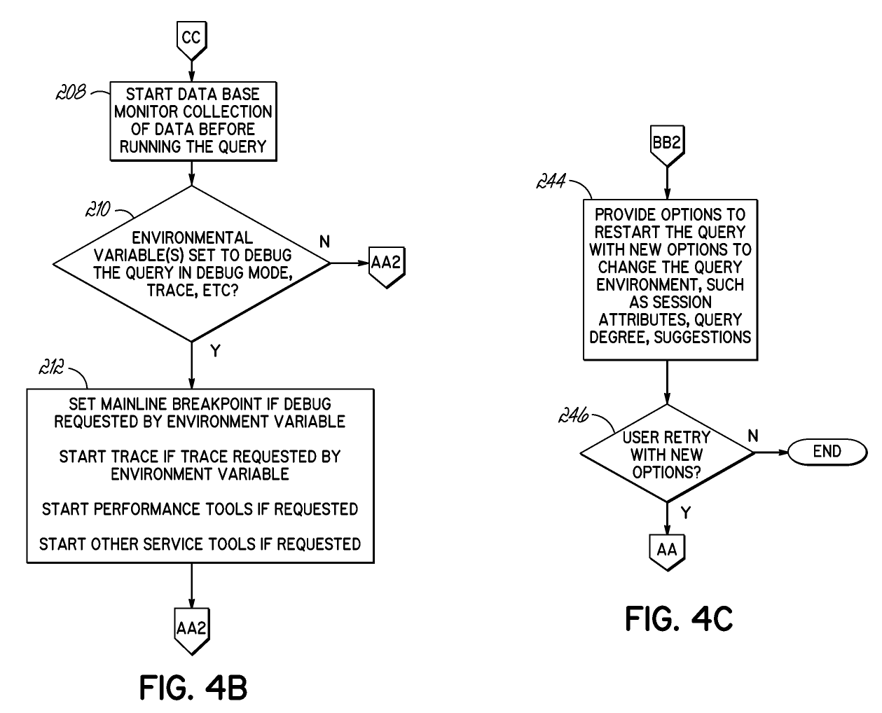

FIG. 4A illustrates a flowchart 200 that includes blocks of program code executable to determine whether a query is associated with an error history as well as perform remedial actions thereupon consistent with embodiments of the invention. Initially, the query is processed (block 202). The program code may then analyze information about the processing and/or access plan about the query to determine any function checks of the query (block 204). In some embodiments, there is no relevant history for a query. For example, there may be no relevant history for a query when a query is run for the first time, or when a new user is first evaluating the query.

The program code then evaluates whether a system-generated error history associated with the query has exceeded a threshold “K” (e.g., whether the query is a “problem” query) (block 206). When the error history of the query has exceeded the threshold K (e.g., the error history indicates that the query has been terminated K+1 number of times) (“Yes” branch of decision block 206), pre-processing may be performed on the query as illustrated in FIG. 4B before that query is executed.

With reference to FIG. 4B, and in response to the determination that the termination history of the query has exceeded the termination threshold K (“Yes” branch of decision block 206), data may be collected by a database monitor (block 208) and environmental variable associated with the query may be checked (block 210). When at least one environmental variable has been set to include a processing request, (e.g., for example, the use of debug mode, trace, and/or another service tool (“Yes” branch of decision block 210)), the processing settings associated with the query are changed accordingly (block 212).

Returning to FIG. 4A, in response to determining that the termination history of the query has not exceeded the termination threshold K (“No” branch of decision block 206), in response to determining that at least one environmental variable has not been set (“No” branch of decision block 210) and/or in response to changing processing settings associated with the query (block 212), the query is executed (block 214). It may then be determined whether the query is associated with a function check (e.g., for example, as the query is processed and/or after the query is processed) (block 216). When the query is not associated with a function check (“No” branch of decision block 216), the query completes normally (block 218).

When the query is associated with a function check (“Yes” branch of decision block 216), the system evaluates whether the error history, including the present error, meets the threshold K such that the query is a “problem” query (decision block 230). When the error history of the query has not exceeded the termination threshold N (“No” branch of decision block 230), the query is terminated normally in response to the error (block 232). When the threshold has been reached (“Yes” branch of decision block 230), the termination information is saved to the query access plan (block 234), and corrective options are provided to the user as illustrated in FIG. 4C.

With reference to FIG. 4C, the user may be provided an option to restart, continue and/or otherwise re-execute the query (block 244). In some embodiments, the option to re-execute the query may allow the user to change the query environment or query parameters, such as to change various query options to change the query implementation and optimization plan. Moreover, the option may allow the user to change query session attributes, such as changing a degree of parallelism for the query, a job priority of the query, resource allocations, or some other environmental option that would alter the way the query runs. Moreover, the option may provide suggestions to help instruct the user as to query information and/or resolve the performance of the “problem” query. For example, an estimated query completion time may be communicated to the user, informing the user that if they had waited so many seconds or minutes longer, the “problem” query would have completed. As a further example, a suggestion may include information about changes in the environment and optimization plan, or recommend changing the query session attributes, changing the degree of parallelism of the query, changing the job priority of the query, changing the resource allocation to the query, and/or selecting another environmental option that may alter the way the query is processed. Should the user choose to restart, continue and/or re-execute the query (“Yes” branch of decision block 246), the process repeats as illustrated. Should the user choose not to restart, continue and/or re-execute the query (“No” branch of decision block 246) the program code may end.

While all of the present invention has been illustrated by a description of various embodiments and while these embodiments have been described in considerable detail, the applicant does not intend to restrict or in any way limit the scope of the appended claims to such detail.

For example, the blocks of any of the flowcharts may be re-ordered, processed serially and/or processed concurrently without departing from the scope of the invention. Moreover, any of the flowcharts may include more or fewer blocks than those illustrated consistent with embodiments of the invention.

As another example, the operations performed in response to the system's evaluation of the query as a “problem” query may be hidden from the user that initiated the query and may require no input from the user in order to run. Thus, data associated with “problem” queries, and pre-processing designed to aid in the diagnosis of “problem” queries, may be performed for the benefit of a troubleshooter or administrator independent of the user, while the user simply observes the query run to completion. In another embodiment, the user may be informed of some or all of these additional steps. The user, rather than a third party, may also be the recipient of the data collected in some embodiments.

The database administrator for each database installation may specify which data actions are taken when the threshold, “N” and/or “K” as appropriate, is reached. Alternatively, which actions are taken may be defaulted by the system, such as trace tools, performance tools, or other service tools, as appropriate. Additional advantages and modifications will readily appear to those skilled in the art.

The invention in its broader aspects is therefore not limited to the specific details, representative apparatus and method, and illustrative examples shown and described. Accordingly, departures may be made from such details without departing from the scope of the general inventive concept.

What is claimed is:

1. A method of executing a database query in a computing system of the type that includes a query optimizer, the method comprising:
comparing a number of times processing of the database query has been prematurely terminated with a threshold, wherein the number is based upon tracked termination information of the database query; and
automatically collecting diagnostic information about the database query based upon the comparison, wherein the collected diagnostic information is usable for improving a second execution of the database query.

2. The method of claim 1, further comprising analyzing the collected diagnostic information about the database query.

3. The method of claim 1, wherein comparing is performed in response to initiating processing of the database query.

4. The method of claim 1, wherein comparing is performed in response to detecting an attempt by a user to prematurely terminate processing of the database query.

5. The method of claim 4, further comprising:
generating an estimate of an amount of processing time the query will take;
communicating the estimate to the user; and
allowing the user a chance to withdraw the attempt to prematurely terminate processing of the database query.

6. The method of claim 1, wherein comparing is performed in response to detecting a failure that terminates processing of the database query.

7. The method of claim 1, further comprising automatically running the prematurely terminated database query in a background task based on the comparison.

8. The method of claim 7, wherein the background task has a lower priority than the prematurely terminated database query.

9. The method of claim 7, wherein automatically running the prematurely terminated database query in a background task comprises restarting the prematurely terminated database query.

10. The method of claim 7, wherein automatically running the prematurely terminated database query in a background task comprises continuing to run the prematurely terminated database query in the background task.

11. The method of claim 7, wherein automatically running the prematurely terminated database query in the background task comprises running the database query to completion in a batch mode.

12. The method of claim 11, wherein automatically collecting the diagnostic information is performed after completion of the database query in the batch mode.

13. The method of claim 11, wherein automatically collecting the diagnostic information is performed before running the database query in the batch mode.

14. The method of claim 11, wherein automatically collecting the diagnostic information is performed while running the database query in the batch mode.

15. The method of claim 11, wherein the database query is run to completion in a batch mode at a lower priority.

16. The method of claim 1, wherein the number of times processing of the database query has been prematurely terminated and the threshold are associated with a number of user cancellations.

17. The method of claim 1, wherein the number of times processing of the database query has been prematurely terminated and the threshold are associated with a number of program failures.

18. The method of claim 1, wherein the threshold is based upon a number of runs of the database query.

19. The method of claim 1, wherein the threshold is based upon the number of times the database query prematurely terminates.

20. The method of claim 1, wherein the threshold is based upon a proportion of the number of runs of the database query and the number of times the database query prematurely terminates.

21. The method of claim 1, wherein the threshold is based upon a pattern of database query cancellation requests by a user.

22. The method of claim 1, wherein the threshold is based upon a processing time of the database query before the database query was prematurely terminated.

23. The method of claim 1, wherein the threshold is based upon a time when a last query access plan was built.

24. An apparatus comprising:
a processor; and
program code including a query optimizer, the program code configured to be executed by the processor to run a database query,
the program code configured to compare a number of times processing of the database query has been prematurely terminated with a threshold, wherein the number is based upon tracked termination information of the database query; and
the program code further configured to automatically collect diagnostic information about the database query based upon the comparison, wherein the collected diagnostic information is usable for improving a second run of the database query.

25. A program product, comprising:
a computer readable medium; and
program code including a query optimizer, the program code stored on the computer readable medium and configured to execute a database query,
the program code configured to compare a number of times processing of the database query has been prematurely terminated with a threshold, wherein the number is based upon tracked termination information of the database query; and
the program code further configured to automatically collect diagnostic information about the database query based upon the comparison, wherein the collected diagnostic information is usable for improving a second execution of the database query.
